(19) United States
(12) Patent Application Publication
(10) Pub. No.: US 2025/0392666 A1
(43) Pub. Date: Dec. 25, 2025

(54) IMAGE FORMING APPARATUS, INFORMATION PROCESSING METHOD, AND PROGRAM

(71) Applicants: Yuta MAEDA, Tokyo (JP); Koji YANO, Tokyo (JP); Tomohiko KANEKO, Tokyo (JP); Kazuhiro IKEDA, Tokyo (JP); Masaki TSUGAWA, Tokyo (JP)

(72) Inventors: Yuta MAEDA, Tokyo (JP); Koji YANO, Tokyo (JP); Tomohiko KANEKO, Tokyo (JP); Kazuhiro IKEDA, Tokyo (JP); Masaki TSUGAWA, Tokyo (JP)

(21) Appl. No.: 19/247,388

(22) Filed: Jun. 24, 2025

(30) Foreign Application Priority Data
Jun. 24, 2024 (JP) 2024-101146

(51) Int. Cl. H04N 1/00; G03G 15/00; G03G 15/22; G03G 21/16

(52) U.S. Cl. CPC H04N 1/00082; G03G 15/228; G03G 15/502; G03G 15/6552; G03G 21/1633; H04N 1/00037; H04N 1/00076; H04N 1/0009; H04N 2201/0094

(57) ABSTRACT

An image forming apparatus including a scanner to execute a scan operation to read an image from a document medium; a printer to execute a print operation to form the image read by the scanner unit onto a print medium; a discharger to discharge the print medium output from the printer unit; and a detector to detect whether the discharger is in a discharge-possible state. Further, there is determination circuitry configured to determine whether the image on the document medium is readable and control circuitry configured to control the scanner and the printer. When the determination circuitry determines that the image is readable and the detection circuitry indicates that the discharger is in the discharge-possible state, there is a display of a screen prompting the user to select whether to execute the print operation.

### CROSS-REFERENCE TO RELATED APPLICATION

This patent application is based on and claims priority pursuant to 35 U.S.C. §119A to Japanese Patent Application No.2024-101146, filed on Jul. 23, 2024, in the Japan Patent Office, the entire disclosure of which is hereby incorporated by reference herein.

### BACKGROUND

### Technical Field

Embodiments of this disclosure relate to an image forming apparatus, an information processing method, and a program.

### Related Art

An image processing technology is known that automatically reflects the specified corrections to an image read from a document on which handwritten correction instructions are written.

An image forming device is known that reads an image from a document on which corrections (additions or modifications) have been made, extracts an image corresponding to the added parts, and corrects the original image based on the instructions indicated by the extracted parts.

### SUMMARY

In accordance with an embodiment of this disclosure, an image forming apparatus comprising, a scanner unit configured to execute a scan operation to read an image from a document medium; a printer unit configured to execute a print operation to form the image read by the scanner unit onto a print medium; a discharge unit configured to discharge the print medium output from the printer unit; a detection unit configured to detect whether the discharge unit is in a discharge-possible state; a determination unit configured to determine whether the image on the document medium is readable; a control unit configured to control the scanner unit and the printer unit; and an operation unit configured to accept a predetermined specific operation from a user; wherein the control unit, when the determination unit determines that the image is readable and the detection unit indicates that the discharge unit is in the discharge-possible state, displays a screen prompting the user to select whether to execute the print operation; and wherein the control unit, when the determination unit determines that the image is readable and the detection unit indicates that the discharge unit is not in the discharge-possible state, causes the scanner unit to perform the scan operation and, in response to the predetermined specific operation, enables execution of the print operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1: A diagram illustrating an example configuration of an MFP (Multifunction Peripheral) as an image forming apparatus according to one embodiment of the present invention.

FIG. 2: A diagram illustrating the hardware configuration of the MFP.

FIG. 3: A block diagram showing the functional configuration of the image forming apparatus.

FIG. 4A and 4B: Diagrams illustrating a specific example of an operation of the image forming apparatus.

FIG. 5: A diagram illustrating another specific example of an operation of the image forming apparatus.

FIG. 6A and 6B: Flowcharts showing the processing executed by the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described in detail below. As used herein, the singular forms “a,” “an,” and “the” are intended to include the plural forms as well, unless the context clearly indicates otherwise.

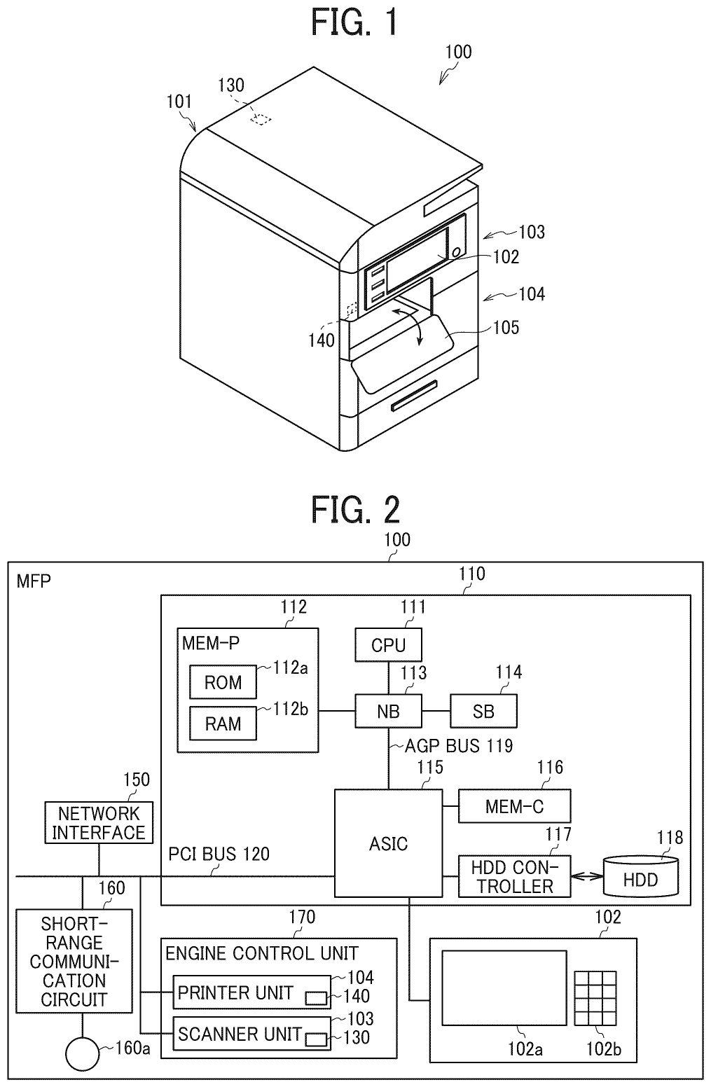

The embodiments of the present invention will now be described in detail with reference to the accompanying drawings. FIG. 1 is a schematic diagram showing an example of an MFP (Multifunction Peripheral Product Printer) 100 as an image forming apparatus in accordance with the present invention.

As shown in FIG. 1, the MFP 100 includes an Automatic Document Feeder (ADF) 101, an operation panel 102, a scanner unit 103, a printer unit 104, and a discharge unit 105. The ADF 101 transports set printing paper (an example of a “medium”) to the scanner unit 103. The scanner unit 103 reads various images and generates image data corresponding to the image (i.e., performs a scanning operation). For instance, the scanner unit 103 reads the image of printing paper conveyed from the ADF 101 and also the image of printing paper placed on the contact glass. In this document, the term “printing paper” may refer to pages or paper printed by the MFP 100, and also refer to a sheet containing any type of text or image which is scanned by the scanner unit 103.

The printer unit 104 prints the image read by the scanner unit 103 onto printing paper (i.e., performs a printing operation). Specifically, the printer unit 104 includes a photosensitive drum and a transfer belt. When an image is read by the scanner unit 103, the image is formed by toner on the photosensitive drum. The image formed on the photosensitive drum is transferred onto the transfer belt (primary transfer) and then from the transfer belt to the printing paper (secondary transfer). The printing paper onto which the image has been transferred is discharged via the discharge unit 105. While this example discloses a toner based printing system, other types of printers and printing systems are possible, such as an ink based or thermal printer or printing systems.

The discharge unit 105 is capable of switching between a state in which the printing paper can be discharged (hereinafter “discharge-possible state”) and a state in which it cannot be discharged. In the specific example of FIG. 1, the discharge unit 105 is assumed to be in the discharge-possible state. The operation panel 102 is configured to display current setting values and selection screens and to receive input from the user (for example, via a touch panel).

In this embodiment, when printing paper is set on the ADF 101 or on the contact glass, a scan operation is automatically executed. In particular, when the operation panel 102 is operated appropriately, the MFP 100 may switch to an automatic execution mode. In addition, the MFP 100 is equipped with a sensor 130 and a sensor 140. The sensor 130 detects whether printing paper has been set on the ADF 101 or on the contact glass, and sensor 140 detects whether the discharge unit 105 is in a discharge-possible state.

When operating in the automatic execution mode, upon detecting that printing paper is set, the MFP 100 automatically executes the scan operation based on the detection result from sensor 140 (i.e., whether the discharge unit 105 is in a discharge-possible state). For example, if printing paper is set during a period when the discharge unit 105 is not in the discharge-possible state (meaning that an image-printed printing paper cannot be discharged), it is inferred that the user desires a scan operation without a print operation. Accordingly, in such cases, the scan operation is executed automatically.

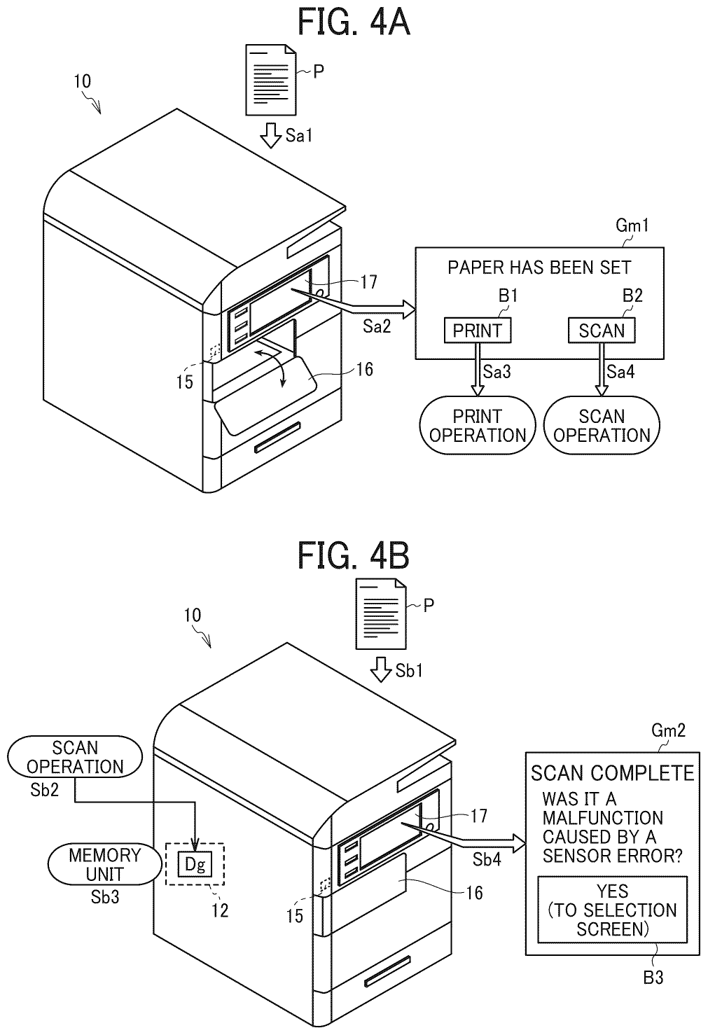

On the other hand, during periods when the discharge unit 105 is in the discharge-possible state and printing paper is set, selection control is executed so that the user may choose whether to execute a print operation or only the scan operation. In this case, the selection control causes a selection screen (designated as Gm1 in FIG. 4A) to be displayed on the operation panel 102, through which the user can select between executing both the scan and print operations or executing only the scan operation.

Thus, with the MFP 100 configured to operate in an automatic execution mode, user convenience is enhanced. However, if a fault occurs in sensor 140, there may be instances where, even though the discharge unit 105 is in the discharge-possible state, that fact is not detected. In such cases, even when the user intends to perform the print operation, only the scan operation is executed, and the print operation is not performed.

If the above situation occurs, it would be necessary to reset the printing paper and re-execute the reading operation to enable the print operation (a configuration hereinafter referred to as the “comparative example”). In such a comparative example, a malfunction in sensor 140 could significantly reduce user convenience. In view of this, the present embodiment adopts a configuration that suppresses such inconveniences.

FIG. 2 is a block diagram illustrating the hardware configuration of the MFP 100. As shown in FIG. 2, the MFP 100 includes a controller 110, a short-range communication circuit 160, an engine control unit 170, an operation panel 102, and a network interface 150.

The controller 110 comprises a CPU (Central Processing Unit) 111, which is the main element of a computer; system memory (MEM-P) 112; a north bridge (NB) 113; a south bridge (SB) 114; an Application Specific Integrated Circuit (ASIC) 115; local memory (MEM-C) 116; an HDD controller 117; and an HDD 118. The north bridge 113 and the ASIC 115 are connected via an AGP (Accelerated Graphics Port) bus 119.

The CPU 111 serves as the control unit that oversees the entire operation of the MFP 100. The north bridge 113 is a bridge or interface that connects the CPU 111 with the MEM-P 112, the south bridge 114, and the AGP bus 119, and it includes a memory controller (for controlling read/write operations to MEM-P 112) as well as a PCI (Peripheral Component Interconnect) master and an AGP target.

The MEM-P 112 is employed for storing programs and data necessary for the operation of the controller 110 and includes a ROM 112a (for storing programs and data) and a RAM 112b (for expanding programs, data, and for image rendering during memory printing). Programs stored in RAM 112b may be in an installable or executable file format recorded on a computer-readable recording medium such as a CD-ROM, CD-R, or DVD.

The SB 114 is a bridge or interface that connects the north bridge 113 with PCI devices and peripheral devices. The ASIC 115 is an integrated circuit incorporating hardware elements for image processing and serves as a bridge connecting the AGP bus 119, PCI bus 120, HDD 118, and MEM-C 116.

The ASIC 115 includes a PCI target, an AGP master, an arbiter (ARB) that forms the core of the ASIC, a memory controller for controlling MEM-C 116, and multiple Direct Memory Access Controllers (DMAC) for performing functions such as image rotation based on hardware logic. In addition, a PCI unit for data transfer between the scanner unit 103 and the printer unit 104 via the PCI bus 120 is provided. The ASIC 115 may also be connected to interfaces for a Universal Serial Bus (USB) or IEEE 1394 (Institute of Electrical and Electronics Engineers 1394).

The HDD (“Hard Disk Drive”) 118 is a storage unit or memory for accumulating image data, storing font data used during printing, and storing forms. The HDD controller 117 controls the read and write operations for the HDD 118 under the control of the CPU 111.

The MEM-C 116 is a local memory used as a copy image buffer and a code buffer. The AGP bus 119 is a bus interface proposed for graphics accelerator cards to accelerate graphic processing by providing high-throughput direct access to the MEM-P 112. The short-range communication circuit 160 includes a sub-circuit 160a and is configured for communications such as NFC (“Near Field Communication”) and Bluetooth.

The engine control unit 170 comprises and/or controls the scanner unit 103 and the printer unit 104. Furthermore, the operation panel 102 or user interface comprises a panel display unit 102a for displaying current settings and selection screens, and an operation unit 102b that includes a numeric keypad for inputting conditions related to image formation (e.g., density settings) as well as a start key for initiating a copy operation.

The controller 110 controls the overall operation of the MFP 100, for example, executing functions such as image rendering, communications, and input processing from the operation panel 102. The scanner unit 103 and the printer unit 104 incorporate image processing units that perform tasks such as error diffusion and gamma correction. In addition, the MFP 100 can sequentially switch among functions—including a document box function, a copying function, a printing function, and a facsimile function—via an application switching key on the operation panel 102. When the document box function is selected, the apparatus operates in document box mode; when the copying function is selected, it operates in copy mode; when the printing function is selected, it operates in printing mode; and when the facsimile function is selected, it operates in facsimile mode.

The network interface 150 serves as an interface for data communication over a network. Both the short-range communication circuit 160 and the network interface 150 are electrically connected to the ASIC 115 via the PCI bus 120.

The scanner unit 103 includes sensor 130, which detects whether printing paper is set on the ADF 101 or on the contact glass. For instance, a light sensor that outputs a high signal upon detecting printing paper may be used as sensor 130.

The printer unit 104 includes sensor 140, which detects whether the discharge unit 105 is in a discharge-possible state. Specifically, the discharge unit 105 is equipped with a lid that can move between an open position (where the discharge opening is available) and a closed (blocked) position. The sensor 140 detects whether the lid is in its closed position. For example, a light sensor that outputs a high signal when the lid is in the closed position may be employed as sensor 140.

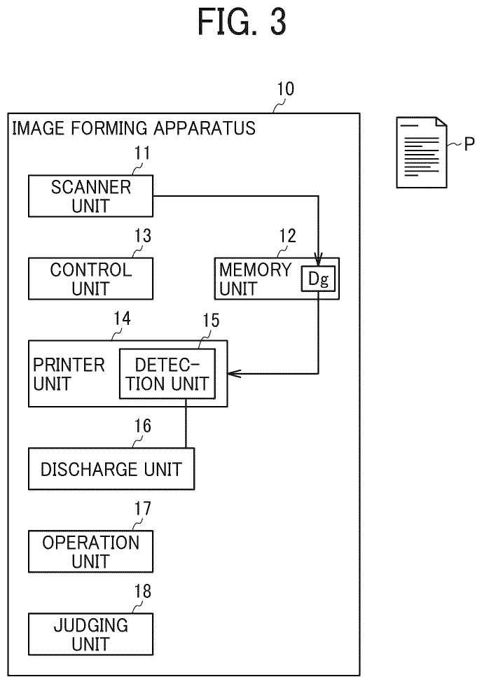

FIG. 3 is a block diagram showing the functional configuration of an image forming apparatus 10 according to the present embodiment. As depicted in FIG. 3, the apparatus comprises:
a scanner unit (or scanner) 11;
a memory unit (or memory) 12;
a control unit (or controller or control circuitry) 13;
a printer unit (or printer) 14;
a detection unit (or detector) 15;
a discharge unit (or discharger) 16;
an operation unit (or operation circuitry or user interface) 17; and
a judging unit (or judging circuitry) 18.

The scanner unit 11 performs a scanning operation to read the image of a reading medium (for example, printing paper P). In the illustrated embodiment, the scanner unit 103 described above may serve as the scanner unit 11. The memory unit 12 stores image data Dg generated by the scanning operation. For example, the RAM 112b described above may function as the memory unit 12. The printer unit 14 performs the print operation that forms the image read by the scanner unit 11 onto an image forming medium. In the present embodiment, the printer unit 104 may correspond to the printer unit 14.

The discharge unit 16 discharges the image forming medium that has been printed by the printer unit 14. For example, the discharge unit 105 described above may function as the discharge unit 16. The detection unit 15 detects whether the discharge unit 16 is in a discharge-possible state; for instance, sensor 140 may function as the detection unit 15. The judging unit 18 determines whether the image of the reading medium is readable.

The control unit 13 is configured to control both the scanner unit 11 and the printer unit 14. For example, the controller 110 described above may serve as the control unit 13. Specifically, when the judging unit 18 determines that the image of the reading medium is readable and when the detection unit 15 confirms that the discharge unit 16 is in a discharge-possible state, the control unit 13 executes a selection control that permits the user to choose whether to execute the printing operation.

Although the details of the selection control will be described later, the selection control causes a selection screen designated Gm1 (see FIG. 4A) to be displayed on the operation panel 102. By touching the selection screen appropriately, the user can choose to have the print operation executed following the scan operation or to execute only the scan operation.

Thus, if a user wishes to perform only a scan of printing paper P (that is, does not wish to execute the print operation), it is sufficient to set the printing paper P in a position where the image can be read while placing the discharge unit 16 in a state where discharge is not possible (for example, by closing the lid). With this configuration, the operation panel 102 need not be manipulated when only a scan operation is desired. Accordingly, compared with a configuration in which the operation of the operation panel 102 is mandatory during the scan operation, user convenience is improved.

However, if a malfunction occurs in the detection unit 15 (which detects the state of the discharge unit 16), there may be instances where, even though the discharge unit 16 is in the discharge-possible state, this state is not correctly detected. In such cases, even if the user wishes to execute the print operation, only the scan operation may be executed, and the print operation would not be performed-thereby creating an inconvenience.

To suppress the aforementioned inconvenience, the image forming apparatus 10 of the present embodiment includes an operation unit 17 that is capable of accepting a predetermined specific operation. In addition, even when the detection result from the detection unit 15 indicates that the discharge unit is not in a discharge-possible state (including cases where a malfunction in the detection unit 15 results in a “not discharge-possible” indication), the apparatus is configured to perform the print operation in response to a specific operation. Specifically, when the detection result indicates a non-discharge-possible state, the scan operation is executed and, when image data Dg generated by the scan operation is stored in the memory unit 12, a confirmation screen Gm2 is displayed (see FIG. 4B).

The confirmation screen Gm2 is displayed, for example, on the operation panel 102. Should the print operation fail to execute unintentionally due to a malfunction of the detection unit 15, the user can, by appropriately touching the confirmation screen Gm2, cause the print operation to be executed. Thus, the above configuration effectively suppresses the inconvenience of a desired operation not being carried out.

Furthermore, as will be described in detail later, if a scan operation is executed contrary to the user's intention, then upon receiving a subsequent specific operation the image data Dg stored in the memory unit 12 from the prior scan operation is used to execute the print operation. In this configuration, even when a scan operation is executed undesirably, the image data Dg stored as a result is effectively utilized for the subsequent print operation. Therefore, compared to a configuration requiring a re-scan operation, the overall time required to complete the print operation is reduced.

FIG. 4A illustrates a specific example of the operation of image forming apparatus 10. In this example, it is assumed that the apparatus is set to the automatic execution mode, and that the discharge unit 16 is in a discharge-possible state for discharging printing paper. Under these conditions, when printing paper P is set into the apparatus, the aforementioned selection control is executed automatically.

Specifically, when printing paper P is set in an appropriate position, it is determined that the image of printing paper P is readable (step Sa1 in FIG. 4A). Furthermore, if the discharge unit 16 is in a state enabling the discharge of printing paper, then normally (assuming the detection unit 15 is functioning properly) the detection result from unit 15 also indicates a discharge-possible state. Under these circumstances, the selection screen Gm1 is displayed on the operation unit 17 (step Sa2 in FIG. 4A).

FIG. 4A schematically illustrates an example of the selection screen Gm1. As shown, the selection screen Gm1 comprises a print button B1 and a scan button B2. When the print button B1 is touched (step Sa3 in FIG. 4A), the print operation is executed so that the image of printing paper P, which was set in step Sa1, is printed; the printing paper with the printed image is then discharged from discharge unit 16. Conversely, when the scan button B2 is touched (step Sa4 in FIG. 4A), the scan operation is executed, thereby reading the image of printing paper P.

FIG. 4B illustrates another specific example of the operation of image forming apparatus 10. In this example, similar to FIG. 4A, the apparatus is assumed to be in automatic execution mode; however, the example here assumes that the discharge unit 16 is in a state in which printing paper cannot be discharged (i.e., the lid member is in a blocked state). When printing paper P is set into the apparatus (step Sb1 in FIG. 4B), the scan operation to read the image of printing paper P is executed automatically (step Sb2 in FIG. 4B), and the image data Dg generated by the scan operation is stored in the memory unit 12 (step Sb3 in FIG. 4B).

Upon execution of the scan operation, the confirmation screen Gm2 is displayed on the operation unit 17 (step Sb4 in FIG. 4B). FIG. 4B also shows a schematic example of the confirmation screen Gm2. As shown, Gm2 displays a message indicating that the scan operation has been completed, along with a message to confirm that no erroneous operation has occurred due to a malfunction of the detection unit 15, and it displays a retry button B3.

When the retry button B3 is touched, the print operation becomes executable. In cases where, due to a malfunction of the detection unit 15, the print operation has not executed as intended, the user can touch the retry button B3 to trigger the print operation. In the specific example of FIG. 4B, it is assumed that the detection result from unit 15 is normal—in which case, operation of the retry button B3 by the user is not necessary.

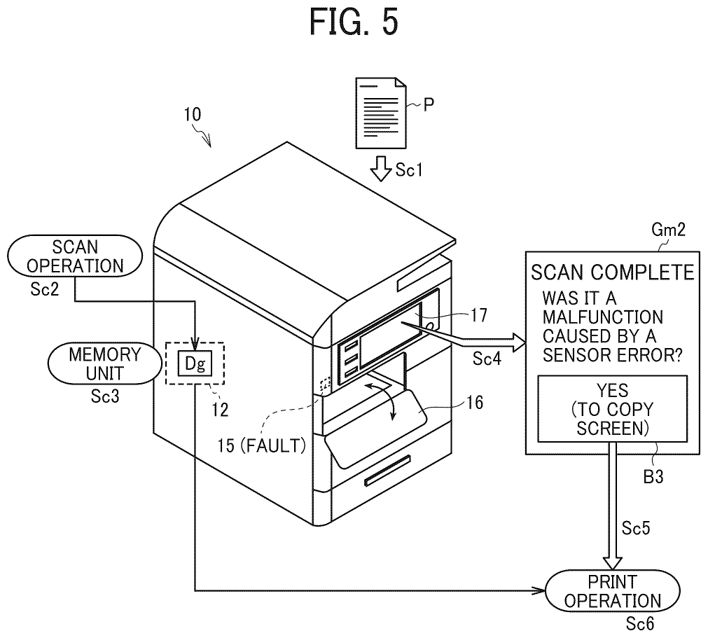

FIG. 5 shows yet another specific example of the operation of image forming apparatus 10. In this example, as in FIGS. 4A and 4B, the apparatus is set to the automatic execution mode.

In the example of FIG. 5, similar to the example of FIG. 4A, it is assumed that the discharge unit 16 is in a discharge-possible state. However, in the FIG. 5 example, although the actual discharge unit 16 is capable of discharging printing paper, the detection result from the detection unit 15 incorrectly indicates a “not discharge-possible” state. This situation is assumed to occur, for example, when the detection unit 15 is faulty.

In the FIG. 5 example, when printing paper P is set into the image forming apparatus 10 (step Sc1 in FIG. 5), the scan operation to read the image of printing paper P is executed automatically (step Sc2 in FIG. 5), and the resulting image data Dg is stored in the memory unit 12 (step Sc3 in FIG. 5). However, even though the discharge unit 16 is actually in a discharge-possible state, the print operation is not executed because the detection result from the detection unit 15 is inaccurate—thus an erroneous operation contrary to the user's intention is carried out.

As described above, when the scan operation is executed in the automatic execution mode (see FIG. 4B), the confirmation screen Gm2 is displayed (step Sc4 in FIG. 5). If the print operation has not been executed contrary to the user's intention, the user may touch the retry button B3 on the confirmation screen Gm2. When the retry button B3 is touched (step Sc5 in FIG. 5), the image forming apparatus 10 executes the print operation (step Sc6 in FIG. 5). Thus, according to the present embodiment, the inconvenience of the print operation not being executed when desired is suppressed.

In this embodiment, the print operation executed in response to touching the retry button B3 uses the image data Dg that had been stored in the memory unit 12 as a result of the previously executed (and unintended) scan operation. For example, in the FIG. 5 example, the print operation executed at step Sc6 employs the image data Dg stored in step Sc3 (which was generated by the scan operation executed contrary to the user's intention).

In the above configuration, in the print operation triggered by the retry button B3, it is not necessary to generate new image data Dg by re-reading printing paper P. For example, in the FIG. 5 example, at step Sc7 of the print operation, the image reading operation is not performed and new image data Dg is not generated. Thus, compared to a configuration requiring new image data generation, the overall time required to complete the printing operation is reduced.

In the present embodiment, the control is configured such that the print operation is automatically executed upon a touch input to the retry button B3; however, the control executed upon touching the retry button B3 is not limited to the above example. For example, in an alternative configuration, when the retry button B3 is touched the selection screen Gm1 may be displayed. Then, if the print button B1 on Gm1 is touched, the print operation is executed.

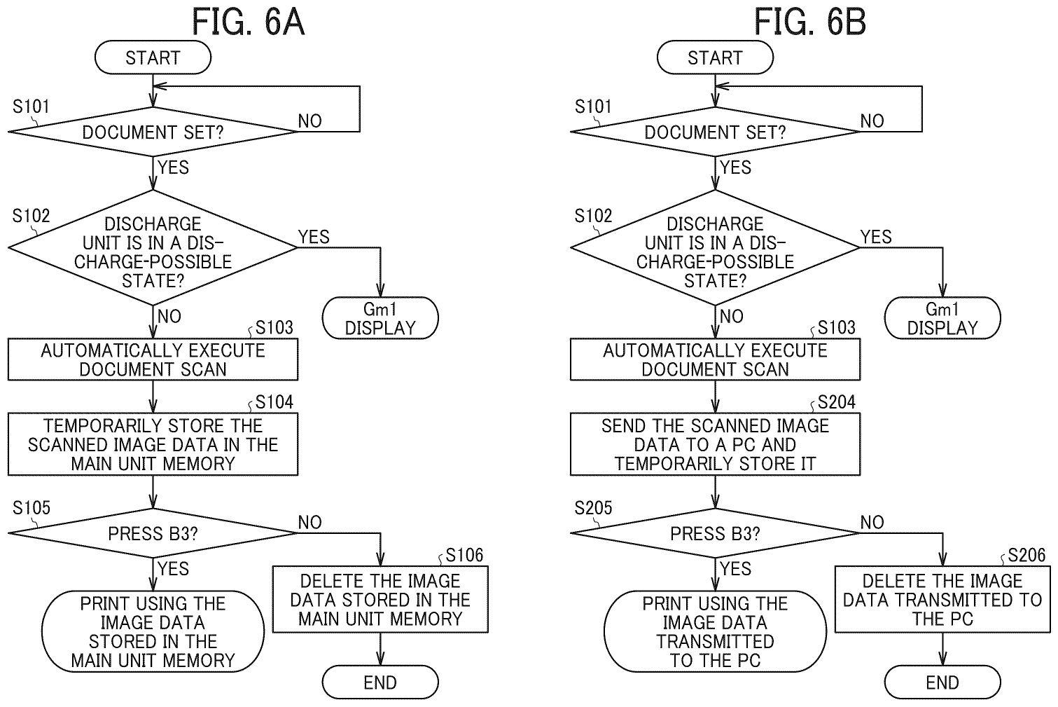

FIG. 6A is a flowchart illustrating the processing executed by image forming apparatus 10 in this embodiment. In the automatic execution mode, the image forming apparatus 10 carries out the processing shown in FIG. 6A.

In the automatic execution mode, the apparatus first determines whether the original document sheet is set in a readable condition (step S101). Specifically, based on the detection result from sensor 130, the apparatus determines whether the document sheet is appropriately positioned for reading. The process repeats step S101 until the document sheet is set.

When the document sheet is set appropriately (S101: Yes), the apparatus then determines whether the discharge unit 16 is in a discharge-possible state (step S102). Based on the detection result from the detection unit 15, it is determined whether unit 16 is in a discharge-possible state. As explained, if the detection unit 15 operates normally and unit 16 is in a discharge-possible state, the detection result will indicate “discharge possible.” However, if a malfunction occurs in the detection unit 15, there may be cases where unit 16 is actually in a discharge-possible state yet the result is not “discharge possible.”

If the detection result is “discharge possible” (S102: Yes), the apparatus displays the selection screen Gm1 as described earlier (see FIG. 4A). Through this screen, the user may select either the print operation or the scan operation. The image forming apparatus 10 then executes the operation selected by the user via the selection screen Gm1.

If the detection result is not “discharge possible” (S102: No), the apparatus executes the scan operation (step S103) and stores the resulting image data Dg in the memory unit 12 (step S104). Note that if a malfunction occurs in detection unit 15, even though the user desires the print operation, the apparatus may evaluate the condition as “No” at step S102 and thereby execute only the scan operation in step S103.

Once the scan operation is executed and image data Dg is stored in the memory unit 12, the confirmation screen Gm2 (see FIG. 4B) is displayed. During the period that Gm2 is displayed, the apparatus monitors whether the retry button B3 is touched (step S105).

The confirmation screen Gm2 remains displayed until a new touch input is received on the operation panel 102. If the retry button B3 is not touched (S105: No), the apparatus deletes the stored image data Dg from the memory unit 12 and terminates the process illustrated in FIG. 6A. Conversely, if the retry button B3 is touched (S105: Yes), the apparatus executes the print operation using the stored image data Dg.

Thus, in the present embodiment, if the retry button B3 is touched, the print operation is executed using the image data Dg stored in step S103 (as a result of an erroneous operation). Consequently, compared to a configuration in which image data Dg must be freshly generated, the time required to complete the print operation is reduced.

In the foregoing embodiment, the image data Dg used when the retry button B3 is touched is stored by the image forming apparatus 10 (in memory unit 12); however, a configuration in which the image data Dg is stored in an external apparatus may also be adopted. A variation employing such a configuration is described below with reference to FIG. 6B.

FIG. 6B is a flowchart illustrating this variation. In the variation, the image forming apparatus 10 executes the process shown in FIG. 6B in automatic execution mode. Steps S101 to S102 are identical to those in FIG. 6A of the earlier embodiment.

In the embodiment of FIG. 6A, the image data Dg generated by the scan operation (step S103) is stored in the apparatus's memory unit 12 (step S104 in FIG. 6A). In the variation shown in FIG. 6B, however, the image data Dg generated by the scan operation is transmitted to an external apparatus and stored there (step S204).

As an example, the external apparatus to which image data Dg is transmitted may be a personal computer (PC) operable by the user. The personal computer is assumed to have a printer driver installed so that it can print the image data (for example, that stored in step S204) by instructing the image forming apparatus 10.

Once the scan operation is executed and the image data Dg is stored on the external apparatus, the confirmation screen Gm2 (see FIG. 4B) is displayed. The apparatus then monitors whether the retry button B3 is touched during the display period (step S205).

If the retry button B3 is not touched (S205: No), the apparatus sends an instruction to the external apparatus to delete the image data Dg (step S206) and terminates the process shown in FIG. 6B. Alternatively, if the retry button B3 is touched (S205: Yes), the apparatus retrieves the image data Dg from the external apparatus and executes the print operation using the retrieved data.

In this variation, as with the embodiment of FIG. 6A, when the retry button B3 is touched the print operation is executed using the erroneously generated image data Dg, thus reducing the time required to complete the print operation compared to a configuration requiring regeneration of the image data.

In the above variation, the external apparatus to which image data Dg is transmitted is not limited to a personal computer. For example, in step S204 the image data Dg may be transmitted to a mobile terminal such as a smartphone. Furthermore, through appropriate user operation of the smartphone, the image data Dg stored therein may be transmitted to the image forming apparatus 10, thereby enabling printing of the image.

In another alternative configuration, the image data Dg may be transmitted to a server (for example, a cloud server). In such a configuration, by appropriate operation of the personal computer or smartphone by the user, the image data Dg is transmitted from the server to the image forming apparatus 10, enabling the print operation. Moreover, by operating the personal computer, the image stored in the image data Dg on a smartphone may likewise be printed by the apparatus.

For the various embodiments, each function may be implemented by one or more processing circuits. Here, the term “processing circuit” as used herein includes a processor (such as a CPU implemented by an electronic circuit) programmed via software to execute each function, as well as devices including an ASIC (Application Specific Integrated Circuit), a DSP (digital signal processor), an FPGA (field programmable gate array), or conventional circuit modules designed to perform the functions described.

### SUMMARY OF THE EFFECTS AND ADVANTAGES OF THIS EMBODIMENT

### First Embodiment

The image forming apparatus (10) of the first mode comprises:
a scanner unit (11) capable of executing a scan operation to read the image of a reading medium;
a printer unit (14) capable of executing a print operation that forms an image read by the scanner unit onto an image forming medium;
a discharge unit (16) capable of discharging the image forming medium printed by the printer unit;
a detection unit (15) capable of detecting whether the discharge unit is in a discharge possible state;
a judging unit (18) for determining whether the image of the reading medium is readable;
a control unit (13) that controls the scanner and printer units; and
an operation unit (17) capable of accepting a predetermined specific operation.

The control unit, when the judging unit determines that the image is readable and the detection unit indicates that the discharge unit is in a discharge possible state (see FIG. 4A), executes a selection control that allows the user to choose whether to execute the print operation. Conversely, when the judging unit determines that the image is readable while the detection unit indicates that the discharge unit is not in a discharge possible state, the scan operation is executed (see FIG. 4B), and the print operation is subsequently made executable in response to a specific operation (see FIG. 5). According to this mode, the inconvenience caused by the failure to execute a user desired operation is effectively suppressed.

### Second Embodiment

In the image forming apparatus (10) of this embodiment, when the result of the judging unit indicates that the reading is possible and the detection result from the detection unit indicates that the discharge unit is not in a discharge-possible state, the apparatus executes, among the scan and print operations, the scan operation and then, in response to a predetermined specific operation, carries out a selection control. By this embodiment as well, the same advantageous effects as those in the first embodiment are achieved.

### Third Embodiment

The image forming apparatus (10) of this embodiment includes a memory unit (12) for storing image data representing the image of a reading medium obtained by the scan operation. The control unit, when the judging unit's result indicates that the image is readable and the detection unit's result indicates that the discharge unit is not in a discharge-possible state, executes the scan operation and stores the image data obtained thereby in the memory unit. Thereafter, in the print operation executed in response to a predetermined specific operation, the stored image data is used. According to this embodiment, for example, compared to configurations requiring regeneration of image data upon print execution, the time required to complete the print operation is reduced.

### Fourth Embodiment

The image forming apparatus (10) of this embodiment further includes a transmitting unit for sending the image data (obtained by the scan operation) that represents the reading medium's image to an external apparatus, and a receiving unit for receiving such image data from an external apparatus. The control unit, when the judging unit's result indicates that the image is readable and the detection unit's result indicates that the discharge unit is not in a discharge-possible state, executes the scan operation and transmits the image data obtained therefrom to the external apparatus, and thereafter, in the print operation executed in response to a predetermined specific operation, uses the image data received from the external apparatus. This embodiment thus achieves effects similar to those of the third embodiment.

### Fifth Embodiment (Information Processing Method)

An information processing method for an image forming apparatus comprising:
a scanner unit capable of executing a scan operation to read an image of a reading medium;
a printer unit capable of executing a print operation that forms the image read by said scanner unit onto an image forming medium;
a discharge unit capable of discharging the image forming medium produced by said printer unit;
a detection unit capable of detecting whether said discharge unit is in a discharge-possible state;
a judging unit for determining whether the image of the reading medium is readable;
a control unit capable of controlling said scanner and printer units; and
an operation unit capable of accepting a predetermined specific operation; the method comprising the steps of:
   A executing a selection control—in which, if the judging unit's result indicates that the image is readable and the detection unit's result indicates that the discharge unit is in a discharge-possible state, a screen (Gm1, as shown in FIG. 4A) is displayed to allow the user to select whether to execute the print operation; and
   B when the judging unit's result indicates that the image is readable and the detection unit's result indicates that the discharge unit is not in a discharge-possible state, executing the scan operation (among the scan and print operations) and, in response to a predetermined specific operation, rendering the print operation executable (by displaying a screen Gm2 as shown in FIG. 5).

According to this embodiment, the same advantageous effects as those in the first embodiment are obtained.

### Sixth Embodiment (Program)

A program and a non-transitory computer readable medium storing the program for causing a computer to execute the steps of the information processing method of the fifth embodiment. According to this embodiment, the same advantageous effects as those in the first embodiment are achieved.

The above-described embodiments have been explained in detail with reference to the present invention. However, the present invention is not limited to the particular embodiments described above, and various modifications and changes can be made within the scope of the invention as defined in the appended claims.

1. An image forming apparatus, comprising:
a scanner to execute a scan operation to read an image from a document medium;
a printer to execute a print operation to form the image read by the scanner onto a print medium;
a discharger to discharge the print medium output from the printer;
a detector to detect whether the discharge is in a discharge possible state;
determination circuitry configured to determine whether the image on the document medium is readable;
control circuitry configured to control the scanner and the printer; and
a user interface to accept a predetermined specific operation from a user;
wherein the control circuitry, when the determination circuitry determines that the image is readable and the detector indicates that the discharger is in the discharge-possible state, displays a screen prompting the user to select whether to execute the print operation; and
wherein the control circuitry, when the determination circuitry determines that the image is readable and the detector indicates that the discharger is not in the discharge-possible state, causes the scanner to perform the scan operation and, in response to the predetermined specific operation, enables execution of the print operation.

2. The image forming apparatus of claim 1, wherein:
the control circuitry is further configured to, when the determination circuitry determines that the image is readable and the detector indicates that the discharger is not in the discharge-possible state, execute the scan operation and, in response to the predetermined specific operation, display a second user selection screen for initiating the print operation.

3. The image forming apparatus of claim 1, further comprising:
a memory for storing image data representing the read image,
wherein, when the determination circuitry determines that the image is readable and the detector indicates that the discharger is not in the discharge-possible state, the control circuitry:
causes the scanner to perform the scan operation and stores the resulting image data in the memory; and
in response to the predetermined specific operation, causes the printer to execute the print operation using the image data stored in the memory.

4. The image forming apparatus of claim 1, further comprising:
a transmitter configured to send the image data obtained by the scan operation to an external device; and
a receiver configured to receive image data from the external device;
wherein, when the determination circuitry determines that the image is readable and the detector indicates that the discharger is not in the discharge-possible state, the control circuitry:
causes the scanner to perform the scan operation and transmits resulting image data to the external device via the transmitter; and
in response to the predetermined specific operation, causes the printer to execute the print operation using the image data received from the external device via the receiver.

5. The image forming apparatus of claim 1, further comprising:
an automatic document feeder to transport the document medium to the scanner.

6. The image forming apparatus of claim 1, wherein:
the printer comprises a toner-based printing system.

7. The image forming apparatus of claim 1, wherein:
the discharger includes a lid movable between an open position corresponding to the discharge-possible state, and a closed position, and
the detector is to detect a position of the lid.

8. The image forming apparatus of claim 1, wherein:
the control circuitry is configured to operate in an automatic execution mode in which, upon the determination circuitry determining that the document medium is set, the control circuitry automatically initiates control of the scanner based on whether the detector indicates the discharger is in the discharge-possible state.

9. The image forming apparatus of claim 1, wherein:
the control circuitry is further configured to display a confirmation screen on the user interface after the scanner performs the scan operation, the confirmation screen including an option for the user to provide the predetermined specific operation, when the determination circuitry determines that the image is readable and the detector indicates that the discharger is not in the discharge-possible state.

10. The image forming apparatus of claim 1, further comprising:
a memory,
wherein when the determination circuitry determines that the image is readable and the detector indicates that the discharger is not in the discharge-possible state, the control circuitry causes the scanner to perform the scan operation and store image data from the scan operation in the memory, and
wherein the enabled execution of the print operation in response to the predetermined specific operation uses the image data stored in the memory.

11. A method comprising:
detecting whether a discharger is in a discharge-possible state;
determining whether an image is readable;
displaying a user selection screen for initiating a print operation when the determining determines that the image is readable and the detecting detects that the discharger is in a discharge-possible state;
executing a scan operation, when the determining determines that the image is readable and the detecting detects that the discharger is not in a discharge-possible state; and
performing a print operation in response to a predetermined specific operation.

12. The method of claim 11, wherein performing the print operation in response to the predetermined specific operation comprises:
in response to the predetermined specific operation, displaying a second user selection screen for initiating the print operation; and
initiating the print operation in response to a selection made on the second user selection screen.

13. The method of claim 11, further comprising:
storing the image data obtained from executing the scan operation in a memory when the discharger is detected not to be in the discharge-possible state; and
wherein performing the print operation comprises printing the image data stored in the memory.

14. The method of claim 11, further comprising:
transmitting the image data obtained from executing the scan operation when the discharger is detected not to be in the discharge-possible state to an external device; and
receiving the image data from the external device;
wherein performing the print operation comprises printing the image data received from the external device.

15. The method of claim 11, wherein:
executing the scan operation comprises reading the image from the document medium that has been transported by an automatic document feeder.

16. The method of claim 11, wherein:
performing the print operation comprises forming an image corresponding to the image data onto the print medium using a toner-based printing process.

17. The method of claim 11, wherein:
the discharger includes a lid movable between an open position and a closed position, and wherein detecting whether the discharger is in the discharge-possible state comprises detecting whether the lid is in the open position, the open position corresponding to the discharge-possible state and the closed position corresponding to a state where the discharger is not in the discharge-possible state.

18. The method of claim 11, wherein:
the determining that the image on the document medium is readable comprises determining that the document medium has been set for scanning, and
when the document medium is determined to be set and readable, automatically proceeding to the step of displaying the first user selection screen or the step of executing the scan operation, based respectively on whether the discharger is detected to be in the discharge-possible state or not in the discharge-possible state.

19. The method of claim 11, further comprising:
when the determining determines that the image on the document medium is readable and the detecting detects that the discharger is not in the discharge-possible state, after executing the scan operation, displaying a confirmation screen, the confirmation screen providing an option for the user to input the predetermined specific operation.

20. A non-transitory computer-readable medium storing instructions that, when executed by a processor in an image forming apparatus, cause the apparatus to perform the steps of the method of claim 11.
